(19) United States
(12) Patent Application Publication
(10) Pub. No.: US 2010/0110953 A1
(43) Pub. Date: May 6, 2010

(54) METHOD FOR TRANSMITTING PHASING INFORMATION AND PHASING METHOD IN MOBILE COMMUNICATION SYSTEM

(75) Inventors: Jae-Heung Kim, Daejon (KR); Kyoung-Seok Lee, Daejon (KR); Jung-Im Kim, Daejon (KR); Byung-Han Ryu, Daejon (KR); Seung-Chan Bang, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/531,277

(22) PCT Filed: Mar. 21, 2008
(86) PCT No.: PCT/KR2008/001627

§ 371 Date: Sep. 14, 2009

(30) Foreign Application Priority Data
Mar. 21, 2007 (KR) 10-2007-0027448

(51) Int. Cl. G08C 17/00; H04W 72/04

(52) U.S. Cl. 370/311; 370/329

(57) ABSTRACT

The present invention relates to a method of transmitting paging information and a paging method in a mobile communication system. According to the invention, in a case of starting to transmit downlink information to mobile stations that do not maintain uplink synchronization while performing a low-power-consumption operation in an active state, the start of the information transmission is informed by transmitting a medium access control (MAC) paging message to the mobile stations. In this case, the invention can inform the mobile station that the MAC paging message exists in a physical layer control channel or can transmit the generated MAC paging message through only the physical layer control channel. Accordingly, the invention can efficiently transmit the paging information while maximizing utilization of a limited radio resource.

### TECHNICAL FIELD

The present invention relates to a method of transmitting paging information in a mobile communication system. More particularly, the invention relates to a method of transmitting paging information to a mobile station performing a low-power-consumption operation and a paging method that is performed by the mobile station based on the paging information.

### BACKGROUND ART

Generally, in an existing mobile communication system, when a mobile station receives data or when information is changed in the system and the changed information is transmitted to the mobile station, paging is performed. In order to transmit paging information, the existing mobile communication system utilizes a fixed transport channel and a physical channel.

In a 3rd Generation Partnership Project (3GPP) system of a Wideband Code Division Multiple Access (WCDMA) type, a paging channel is transmitted through a secondary common control physical channel (S-CCPCH) that is a physical layer channel for transmitting common control information. The S-CCPCH may be mapped by a paging channel and a forward access channel (FACH) that is a transport channel having a similar attribute to the paging channel.

In this WCDMA system of the related art, a radio resource is assigned by allocating a code index of an orthogonal variable spreading factor (OVSF) with orthogonality. Therefore, a separate OVSF code index is allocated to the S-CCPCH. This means that a physical layer channel different from the OVSF code index allocated to the S-CCPCH should be used or may not share the OVSF code index allocated to the S-CCPCH.

Accordingly, although there is no information to be transmitted from a base station to the mobile station by using the transport channels PCH and FACH, the S-CCPCH exists. Furthermore, although there is no information to be transmitted to the S-CCPCH, the OVSF code index and another radio resource, i.e., power, are allocated. For this reason, there is a problem that the radio resource is wastefully used.

A general paging procedure is as follows. The mobile stations are included in one of paging groups defined for an efficient paging procedure. The base station informs the mobile stations included in a preferred group that a paging message transmitted through a paging channel exists, through a paging indication channel (PICH) that is a physical layer channel. The mobile stations monitor the PICH every predetermined cycle. Upon monitoring the PICH, when the PICH includes indication information corresponding to the group in which a mobiles station is included, the mobile station searches PCH channel information to be transmitted through the S-CCPCH. When searching the PCH, the mobile station demodulates the paging information by receiving the paging information in which an identifier exists. Furthermore, the mobile stations perform the following procedures corresponding thereto based on the demodulated paging information. This paging procedure is performed to mobile stations that are in an idle state. Here, the identifier indicating the mobile station may include, for example, IMSI (International Mobile Subscriber Identity), TMSI (Temporary Mobile Subscriber Identity), U-RNTI (UMTS Terrestrial Radio Access Network-Radio Network Temporary Identifier).

Meanwhile, a plurality of S-CCPCHs may be employed so as to obtain paging capability according to an environment of the base station and the capacity for subscribers of the base station. The S-CCPCH is a cell-specific parameter, and when the base station is installed, the S-CCPCH is fixedly employed. According to the method of fixedly employing the paging channel and the S-CCPCH in consideration of the maximum capacity, the radio resource is wastefully used, but a circuit-based system can be stably employed.

However, it is difficult to apply the above-described method to a packet-based system such as a long term evolution (LTE) system of which standardization is currently in progress. Even though the packet-based system is an active state in which any packet service may be provided between the base station and the mobile station, the radio resource for receiving and transmitting the packet information is not dedicately provided to the corresponding mobile station until the service is terminated. Furthermore, with respect to both the mobile stations in the idle state and the mobile stations in the active state in the packet-based mobile communication system, a DRX (discontinuous reception) operation is conducted so as to reduce the power consumption of the mobile stations according to a burst characteristic of packet traffic even in an interval in which no transmission data exists. That is, even in a mobile station of an RRC_Connected state that maintains a radio resource control (RRC) connection such that the base station and the mobile station provide the packet service, it is possible to conduct the DRX operation for the purpose of low-power consumption by control of the base station. Accordingly, in the mobile communication system for providing the packet service having the burst characteristic, an efficient method is required for informing the mobile stations of the RRC_Connected state in which a downlink transmission restarts, while utilizing more efficient and variable radio resources.

### DETAILED DESCRIPTION

### Technical Object

The object of the invention is to provide a method of transmitting paging information to a mobile station that performs a low-power-consumption operation in an active state in a packet-based mobile communication system.

In addition, the object of the invention is to provide a method of performing paging by the mobile station that performs the low-power-consumption operation in the active state.

### Technical Solution

In order to achieve the above-described objects, a method of transmitting paging information indicating the start of downlink information transmission to a mobile station performing a low-power-consumption operation in an active state in a mobile communication system according to an aspect of the invention includes: confirming whether the mobile station maintains uplink physical layer synchronization when the downlink information transmission to the mobile station is started; transmitting a paging message to the mobile station when the mobile station does not maintain uplink physical layer synchronization; and allocating an uplink radio resource to the mobile station by request of uplink synchronization acquisition from the mobile station that receives the paging message.

A method of performing paging by a mobile station that does not maintain uplink synchronization while performing a low-power-consumption operation at an active state in a mobile communication system according to another aspect of the invention includes: receiving a medium access control (MAC) paging message from a base station, as the mobile station starts to transmit downlink information; requesting uplink synchronization acquisition to the base station based on the paging message; and receiving allocation of an uplink radio resource from the base station according to the uplink synchronization acquisition.

### Advantageous Effects

According to exemplary embodiments of the present invention, paging information can be efficiently transmitted to mobile stations performing a low-power-consumption operation in an active state in a system for transmitting packets.

Particularly, the paging information can be transmitted to mobile stations that do not maintain uplink synchronization in the active state in the system for transmitting the packets, and the mobile station performs the paging based on the paging information.

### BRIEF DESCRIPTION OF THE DRAWINGS

FIG. 1 is a schematic structure diagram of a mobile communication system according to an exemplary embodiment of the present invention.

FIG. 2 is a view illustrating an operation state of the mobile station according to the exemplary embodiment of the invention.

FIG. 3 is a flowchart of a method of transmitting paging information according to a first exemplary embodiment of the invention.

FIG. 4 is a flowchart of a method of transmitting paging information according to a second exemplary embodiment of the invention.

FIG. 5 is a first illustrative view of a radio resource for transmitting a paging message in the method of transmitting the paging information according to the second exemplary embodiment of the invention.

FIG. 6 is a first illustrative view of a radio resource for transmitting a paging message in the method of transmitting the paging information according to the second exemplary embodiment of the invention.

FIG. 7 is a second illustrative view illustrating a radio resource for transmitting a paging message in the method of transmitting the paging information according to the second exemplary embodiment of the invention.

### BEST MODE

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

It will be understood that when it is referred to that some parts “include” some constituent elements, this does not exclude the presence of other constituent elements throughout the specification, unless otherwise described in particular.

Furthermore, in this specification, a mobile station (MS) may designate a terminal, a mobile terminal (MT), a subscriber station (SS), a portable subscriber station (PSS), user equipment (UE), an access terminal (AT), and so on. Moreover, the mobile station may include all or a part of functions of the mobile terminal, the subscriber station, the portable subscriber station, the user equipment, and so on.

In this specification, a base station (BS) may designate an access point (AP), a radio access station (RAS), a node B, an ENB (evolved node B), a base transceiver station (BTS), a MMR (mobile multihop relay)-BS, and so on. Moreover, the base station may include all or a part of functions of the access point, the radio access station, the node B, the base transceiver station, the MMR-BS, and so on.

The exemplary embodiments of the invention will now be described with reference to the accompanying drawings.

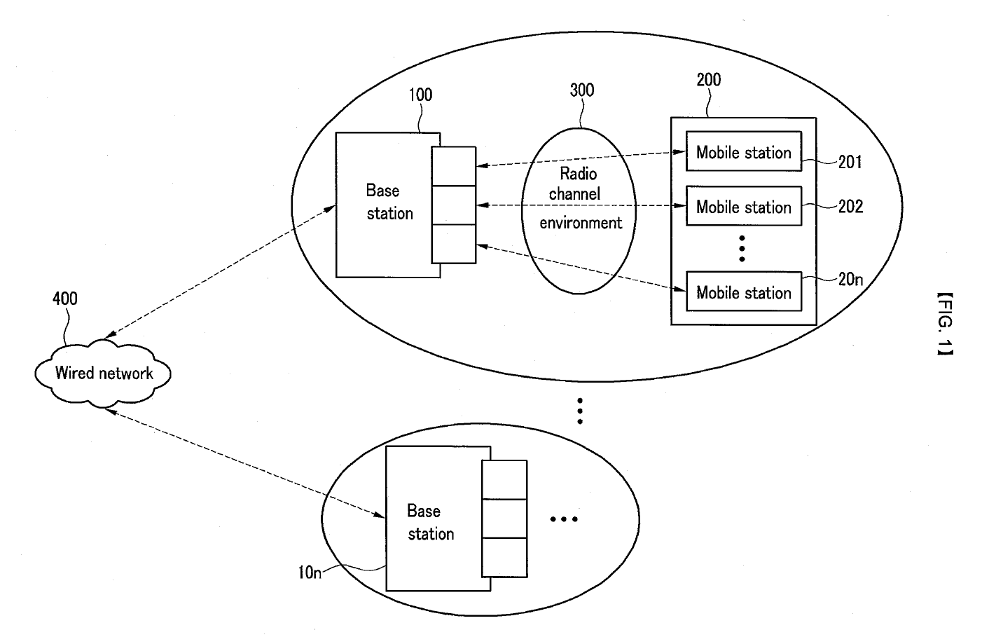

FIG. 1 is a schematic structure diagram of a mobile communication system according to an exemplary embodiment of the present invention.

As illustrated in FIG. 1, according to the mobile communication system of the exemplary embodiment of the invention, one base station 100 transmits and receives data to/from a plurality of mobile stations (201, 202, . . . 20n, n=positive number, and hereinafter, for better comprehension and ease of description, the representative number “200” is allocated to the mobile station) through a radio channel environment 300.

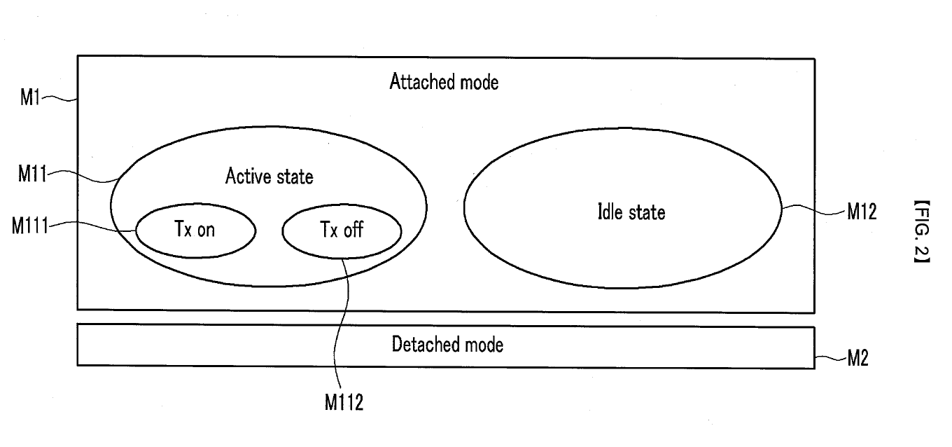

The exemplary embodiment of the invention defines and manages a number of states of the mobile station so as to efficiently manage a limited radio resource. FIG. 2 is a view illustrating a number of states of the mobile station according to the exemplary embodiment of the invention.

As illustrated in FIG. 2, when the mobile station is registered in a network through the base station, the state of the mobile station is defined as an attached mode M1, and when the mobile station is not recognized in the network including the base station and when the mobile station is not registered in the network, the state of the mobile station is defined as a detached mode M2.

The mobile stations in the attached mode may be divided into an active state M11 and an idle state M12 depending on an offer or not of a packet service. In the active state, the mobile station can receive the allocation of the radio resource for transmitting and receiving packet data by controlling a scheduler (not shown) located in the base station. The mobile station in the active state operates in a transmission mode (Tx on) M111 or a transmission stop mode (Tx off) M112 depending on occupation of the radio resource for packet data transmission. The active state of the mobile station corresponds to an RRC (radio resource control) connection state (RRC_Connected) of the LTE system in the attached mode, and the idle state of the mobile station corresponds to an RRC idle (RRC_Idle) state of the LTE system in the attached mode.

The RRC_Connected state is a state of RRC connection between the base station and the mobile station. In this case, the base station manages the mobility of the mobile station. For this purpose, the base station stores and manages an RRC context. The RRC_Idle state is a state without the RRC connection between the base station and the mobile station. In this case, the base station manages the mobility of the mobile station in an aGW (access gateway) located at an upper end thereof.

Since these mobile stations share the radio resource in the base station, the base station 100 performs a function of allocating the radio resource for the packet data transmission to any mobile station (or a group of any mobile stations). This function is generally performed by the scheduler (not shown) in the base station 100. The base station 100 allocates the radio resource in consideration of a radio environment between the mobile station and the base station, a QoS (quality of service) of the packet service, and so on. A separate channel is required so as to transmit information (radio resource allocation information or scheduling information) on the allocated radio resource. For this purpose, a physical layer control channel should be constituted in every scheduling unit (e.g., TTI (transmission time interval)). The radio resource allocation information is composed of downlink radio resource allocation information and uplink radio resource allocation information to be transmitted into the physical layer control channel.

In order to address the allocated radio resource, the radio resource allocation information should include at least the following information.

1) Identifier of mobile station. The identifier classifies the corresponding mobile station (or the group of mobile stations) between the mobile station and the base station, and the identifier is also designated as a scheduling identifier. The identifier can be employed by reserving a part of these identifiers as a group identifier for paging or an indication that informs of generation of downlink information.

2) Information on radio resource block location. The information indicates the location (or interval) of the corresponding radio resource, in the radio resource divided into a frequency domain and a time domain.

3) Modulation scheme. Information indicating whether a certain modulation scheme is applied, of a plurality of modulation schemes used in a system.

4) Coding scheme. Information indicating whether a certain coding scheme is applied, of a plurality of coding schemes used in a system.

Moreover, the radio resource allocation information may include separate information for, for example, retransmission and multi-antenna application.

According to a packet-based mobile communication system, packet data blocks are transmitted to every TTI (or scheduling slot), and each of the packet data blocks is transmitted by means of a channel coding and modulation process. The mobile station or the base station receiving the packet data blocks confirms whether the packet data are normally received by using CRC (cyclic redundancy check) bits that are inserted during an encoding process of the packet data. Moreover, the mobile station or the base station informs the confirmed results by transmitting an ACK (acknowledgement) or a NACK (negative acknowledgement) message to the base station or the mobile station. By means of this HARQ (hybrid automatic repeat request) process, errors can be more efficiently restored in a radio interval, and utilization efficiency of the radio resource can be increased.

Furthermore, according to an OFDM(A)-based mobile communication system, it is necessary to maintain uplink physical layer synchronization so as to transmit the information in uplink. In order to maintain the uplink physical layer synchronization, the base station estimates a reference signal or a preamble signal transmitted from the mobile station and transmits information (for example, TA (timing advance) information), which adjusts transmission time of the mobile station in downlink, based on the estimated reference signal or preamble signal.

The mobile station adjusts its own transmission timing according to TA information. As a result, when signals are transmitted from all of the mobile stations in the base station to the base station, the signals are aligned so as to be received within a CP (cyclic prefix) interval. Due to the adjustment of the uplink physical layer synchronization, orthogonality is maintained between the mobile stations in uplink.

However, in order to maintain the uplink physical layer synchronization with respect to all of the mobile stations in the base station being offered the packet service, the radio resource should be used for the reference signal transmission in uplink and the TA information transmission in downlink. Accordingly, the radio resource for the packet data transmission is reduced. Therefore, when the mobile stations are operated with low power consumption during the offer of the packet service, the base station can control the mobile stations according to radio environment so as to maintain or not maintain the uplink physical layer synchronization. Due to this control, the radio resource is used for the synchronization maintenance of the mobile stations that require the transmission and reception of the packet data, but the radio resource is not used for the synchronization maintenance of the mobile stations that do not require the transmission and reception of the packet data. For this reason, it is possible to improve efficiency of the radio resource.

As described above, according to the packet-based mobile communication system, DRX operation can be performed in the mobile stations that do not switch packets during the packet service so as to reduce consumption of the power. In this case, it is possible to control whether the uplink physical layer synchronization is maintained or not during the DRX operation. The DRX operation operates in a sleep mode for a predetermined cycle in a state in which the mobile station only maintains minimum control channels with respect to the base station. When the cycle elapses, the DRX operation wakes up and confirms whether traffic has been generated or not. If the traffic has been generated, the DRX operation performs a reception operation. If the traffic has not been generated, the DRX operation returns to the sleep mode again. Since the DRX operation repeats the above-described process, the power consumption is low in the DRX operation.

As described above, in order to efficiently use the radio resource and to reduce the power consumption, a method of transmitting paging information in the packet-based mobile communication system will now be described more fully. The paging information is to inform that downlink information transmission to the mobile station starts in the RRC_Connected state.

First, a method of transmitting the paging information and a paging method according to a first exemplary embodiment of the invention will be described.

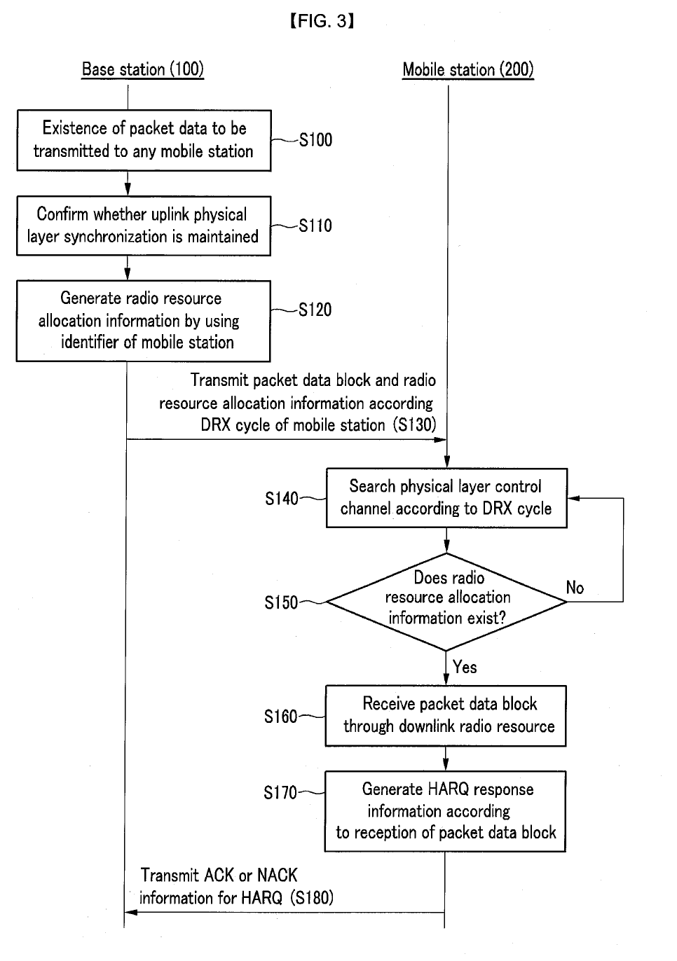

FIG. 3 is a flowchart of the method of transmitting the paging information and the paging method according to the first exemplary embodiment of the invention.

The first exemplary embodiment of the invention relates to transmission of the paging information to the mobile stations that perform the DRX operation and maintain the uplink physical layer synchronization in the RRC_Connected state in the packet-based mobile communication system.

As illustrated in FIG. 3, in a case of again starting the downlink packet service to the mobile stations that perform the DRX operation in the RRC_Connected state, the base station 100 confirms whether packet data or control messages to be transmitted to any mobile station 200 exist (S100).

When the packet data transmitted from an upper layer or the control messages exist in a transmission buffer (not shown), the base station 100 firstly confirms whether the proper mobile station 200 maintains the uplink physical layer synchronization (S110). When the mobile station 200 maintains the uplink physical layer synchronization, the scheduling is previously performed with respect to the proper mobile station and the uplink radio resource is in an allocated state. Accordingly, in this case, the identifier of the corresponding mobile station is included in scheduling-related information to be managed. Therefore, based on whether the identifier of the corresponding mobile station is included in the scheduling-related information, the base station determines whether the mobile station maintains the uplink physical layer synchronization. Moreover, the base station can determine whether the mobile station maintains the uplink physical layer synchronization based on various methods that are capable of being used in the related art.

When the mobile station 200 maintains the uplink physical layer synchronization, the base station 100 constitutes the radio resource allocation information by using the identifier of the corresponding mobile station so as to transmit the packet information (S130). As described above, the radio resource allocation information may include the mobile station identifier, the information on radio resource block location, the modulation scheme, the coding scheme, and so on. Furthermore, the base station 100 transmits the radio resource allocation information through the physical layer control channel and transmits the packet data block through the downlink radio resource allocated to the mobile station according to the DRX cycle of the mobile station (S130).

When performing the DRX operation while maintaining the uplink physical layer synchronization, the mobile station 200 wakes up every DRX cycle and searches whether the radio resource allocation information including the identifier of the mobile station (or group including the mobile station) exists in the physical layer control channel (S140). When the radio resource allocation information including the identifier of the mobile station (or group including the mobile station) exists in the physical layer control channel, the mobile station 200 receives the packet data block, which is transmitted from the base station 100, through the downlink radio resource according to the information on radio resource block location included in the radio resource allocation information (S150˜S160). Furthermore, the mobile station 200 generates HARQ response information according to the reception or not of the packet data block and transmits the HARQ response information to the base station through the uplink radio resource that is previously allocated (S170˜S180).

As described above, according to the first exemplary embodiment of the invention, it is possible to easily transmit the paging information to the mobile stations so as to transmit the downlink packet data, where the mobile stations perform the DRX operation and maintain the uplink physical layer synchronization in the RRC_Connected state.

A method of transmitting paging information and a paging method according to a second exemplary embodiment of the invention will now be described.

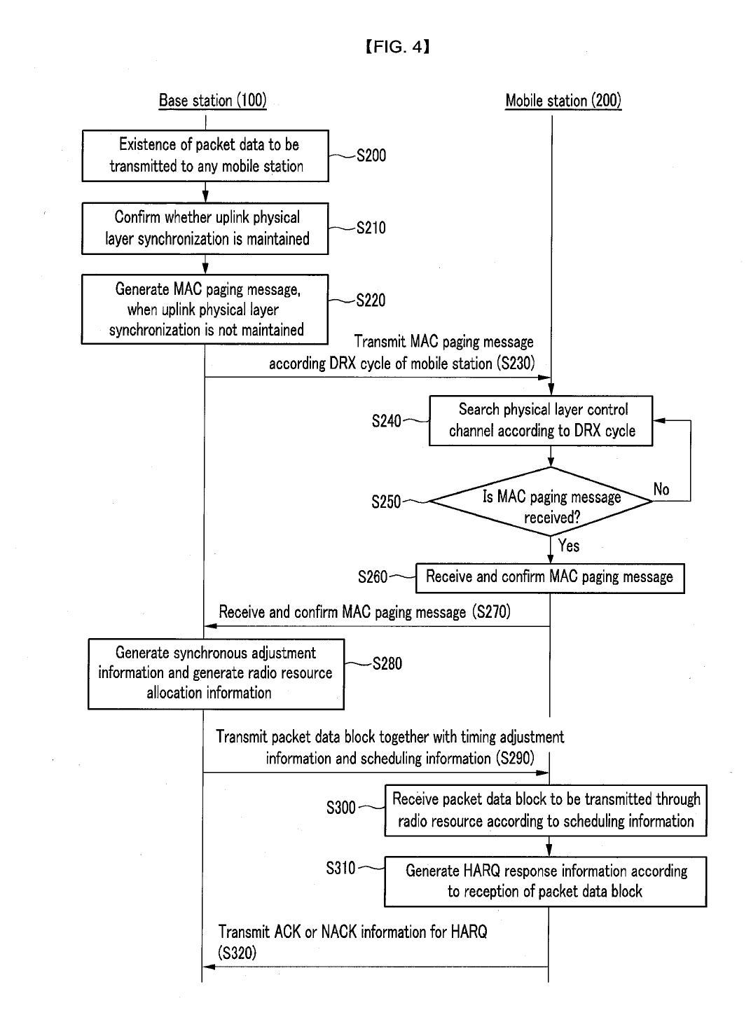

FIG. 4 is a flowchart of the method of transmitting the paging information and the paging method according to the second exemplary embodiment of the invention.

The second exemplary embodiment of the invention relates to transmission of the paging information to the mobile stations that perform the DRX operation and do not maintain the uplink physical layer synchronization in the RRC_Connected state in the packet-based mobile communication system.

As illustrated in FIG. 4, in a case of again starting the downlink packet service to the mobile stations that perform the DRX operation in the RRC_Connected state, if the packet data or the control messages to be transmitted to any mobile station 200 exist, the base station 100 confirms whether the proper mobile station 200 maintains the uplink physical layer synchronization (S200˜S210).

When the mobile station 200 does not maintain the uplink physical layer synchronization, the base station 100 informs the proper mobile station that the downlink receiving information exists and generates a MAC paging message instructing to perform a procedure for acquiring the uplink synchronization (S220). Furthermore, the base station 100 transmits the MAC paging message according to the DRX cycle of the proper mobile station (S230).

The mobile station 200 wakes up every DRX cycle and searches whether the control message or the radio resource allocation information including the identifier of the mobile station (or group including the mobile station) exists in the physical layer control channel (S240). When receiving the MAC paging message, which is transmitted from the base station 100, by the channel search according to the DRX cycle (S250˜S260), the mobile station 200 performs the procedure for acquiring the uplink synchronization (S270). The process for receiving the MAC paging message will be described more fully hereinafter.

At this time, if the base station 100 transmits the packet data block while transmitting the radio resource allocation information on the downlink radio resource without transmitting the MAC paging message from the base station and acquiring the uplink physical layer synchronization by the mobile station, the base station does not receive HARQ response information through the uplink. This reason is that the mobile station 200 can receive the packet data block, which is transmitted through the downlink radio resource, based on the radio resource allocation information transmitted from the base station to the physical layer control channel, but cannot transmit the ACK or NACK response information in the uplink for the purpose of the HARQ. That is, the uplink physical layer synchronization is not maintained. Therefore, when the mobile station 200 transmits the ACK or NACK response information for the HARQ operation without acquiring the uplink physical layer synchronization, the base station 100 does not normally receive the ACK or NACK response information transmitted from the mobile station 200. In this case, this response information also interferes to the feedback signals transmitted from other the mobile stations to the base station.

For this reason, in order to again start the downlink packet service to the mobile stations that do not maintain the uplink physical layer synchronization while performing the DRX operation with low power consumption, as described above, the second exemplary embodiment of the invention informs the mobile station that the receiving information exists and informs to perform the procedure (for example, any random access procedure) for acquiring the uplink synchronization. This procedure is similar to the paging of the existing system and can be defined as a MAC paging procedure for triggering a MAC layer.

Accordingly, when receiving the MAC paging message through the above-described procedure, the mobile station 200 transmits the signal for acquiring the uplink synchronization to the base station 100. For example, in order to acquire the uplink physical layer synchronization, the mobile station 200 selects one preamble pattern (or index) and transmits the generated preamble to the base station 100 based on the selected preamble pattern. The preamble is transmitted during an access slot interval having a predetermined length, and the mobile station 200 transmits the preamble pattern selected during the initial access slot interval.

Meanwhile, when receiving the signal for the synchronous acquisition from the mobile station 200, as illustrated in FIG. 4, the base station 100 generates synchronous adjustment information and generates the radio resource allocation information for transmitting the packet information by using the identifier of the corresponding mobile station (S280). Furthermore, the base station 100 transmits the radio resource allocation information including the synchronous adjustment information to the mobile station 200 (S290). Then, the base station 100 transmits the packet data block through the downlink radio resource allocated to the mobile station 200. Accordingly, the mobile station 200 acquires the uplink physical layer synchronization.

After acquiring the uplink physical layer synchronization, the mobile station 200 confirms whether the radio resource allocation information including the scheduling identifier exists in the physical layer control channel. The mobile station 200 receives the packet data block, which is transmitted from the base station 100, through the downlink radio resource confirmed by the radio resource allocation information (S300). In addition, the mobile station 200 generates the HARQ response information according to the reception of packet data block and transmits the HARQ response information to the base station 100 through the allocated uplink radio resource (S310˜S320).

Due to the above-described processes, it is possible to easily offer the downlink packet data, which are newly offered after acquiring the uplink physical layer synchronization by the MAC paging message, to the mobile stations that do not maintain the uplink physical layer synchronization while performing the DRX operation in the RRC_Connected state.

In the method of transmitting the paging information according to the second exemplary embodiment of the invention, a process for transmitting the MAC paging message will be described more fully hereinafter.

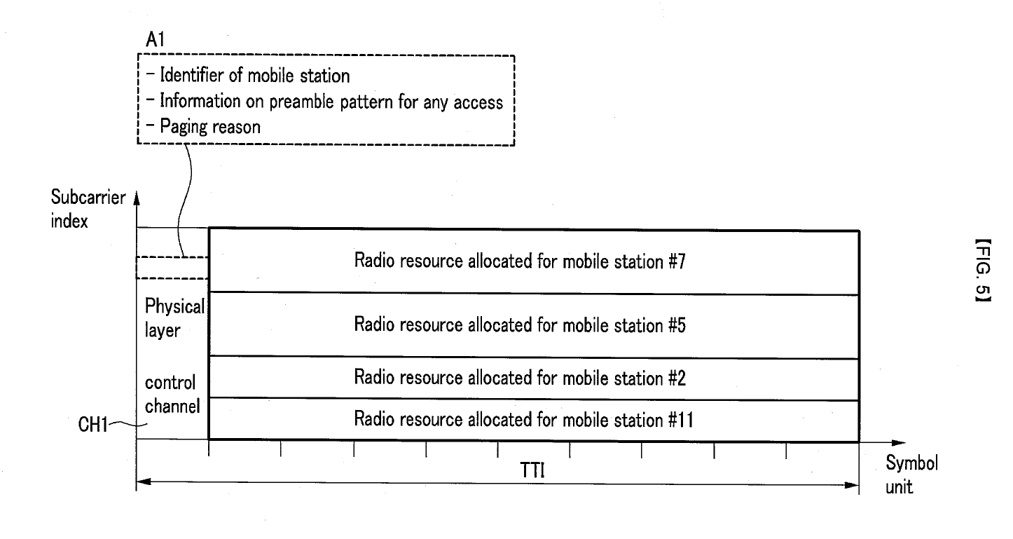

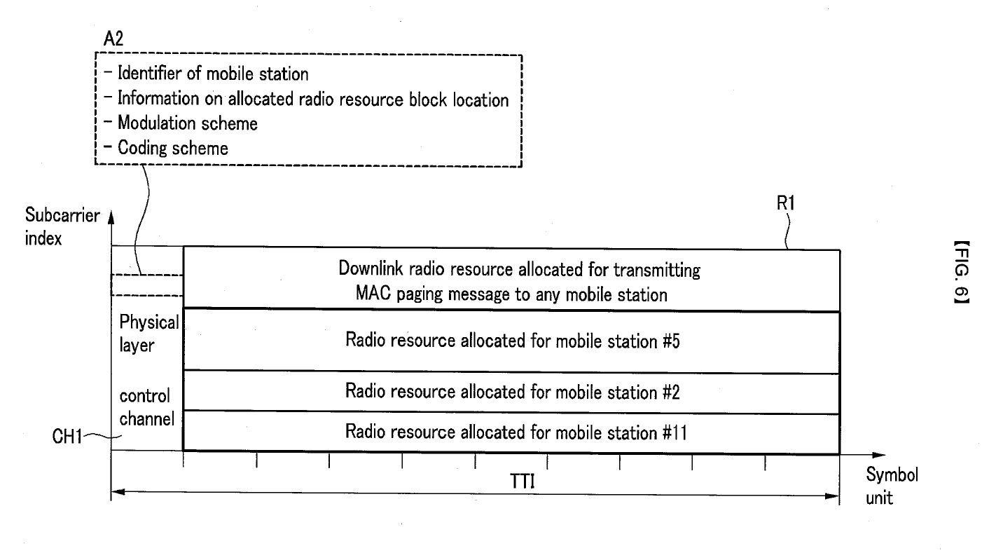

FIG. 5 and FIG. 6 are a first illustrative view of the radio resource for transmitting the paging message in the method of transmitting the paging information according to the second exemplary embodiment of the invention, respectively.

In order to start the downlink packet service to the mobile stations that do not maintain the uplink physical layer synchronization while performing the DRX operation in the RRC_Connected state, the base station generates the MAC paging message instructing to receive the downlink data. Furthermore, the base station transmits the generated MAC paging message to the mobile station through only the physical layer control channel, or can inform the mobile station that the MAC paging message exists in the physical layer control channel by using the identifier.

More particularly, when transmitting the MAC paging message through only the physical layer control channel, as illustrated in FIG. 5, the base station 100 does not allocate the downlink radio resource for transmitting the MAC paging message. In this case, the base station 100 transmits to a physical layer control channel CH1 by constituting the radio resource allocation information A1 for transmitting the MAC paging message. At this time, the radio resource allocation information for transmitting the MAC paging message may include the identifier of the corresponding mobile station, the information on preamble pattern used when performing the procedure of an uplink random access so as to acquire the uplink synchronization, and the information indicating a paging reason.

Accordingly, when receiving the above radio resource allocation information including the own identifier at an interval that monitors the physical layer control channel according to the DRX cycle, the mobile station 200 confirms the paging reason due to the resource allocation information and performs the procedure for acquiring the above-described uplink physical layer synchronization by using the preamble pattern.

Meanwhile, when informing the mobile station that the MAC paging message exists in the physical layer control channel so as to transmit the MAC paging message through the downlink radio resource, as illustrated in FIG. 6, the base station 100 allocates the downlink radio resource R1 for transmitting the MAC paging message. In addition, the base station 100 generates the radio resource allocation information A2 including the identifier of the corresponding mobile station, the information on radio resource block location allocated so as to transmit the MAC paging message, and the encoding and modulation information. In this case, the base station 100 generates the MAC paging message composed of the information on preamble pattern used when performing the procedure of the uplink random access so as to acquire the uplink synchronization and the information indicating the paging reason, and transmits the generated MAC paging message to the mobile station through the downlink radio resource.

Accordingly, when receiving the above radio resource allocation information A2 including the own identifier at the interval that monitors the physical layer control channel CH1 according to the DRX cycle, the mobile station 200 receives the MAC paging message transmitted from the base station 100 by addressing the corresponding block of the downlink radio resource according to the information on radio resource block location included in the radio resource allocation information A2. Furthermore, the mobile station 200 confirms the paging reason due to the MAC paging message and performs the procedure for acquiring the uplink physical layer synchronization described above by using the preamble pattern included in the MAC paging message.

As described above, in a case of transmitting the MAC paging message through the downlink radio resource, it is possible to use a group scheduling identifier reserved for the transmission of the MAC paging message instead of the identifier (or identifier of the corresponding mobile station group) of the mobile station included in the radio resource allocation information.

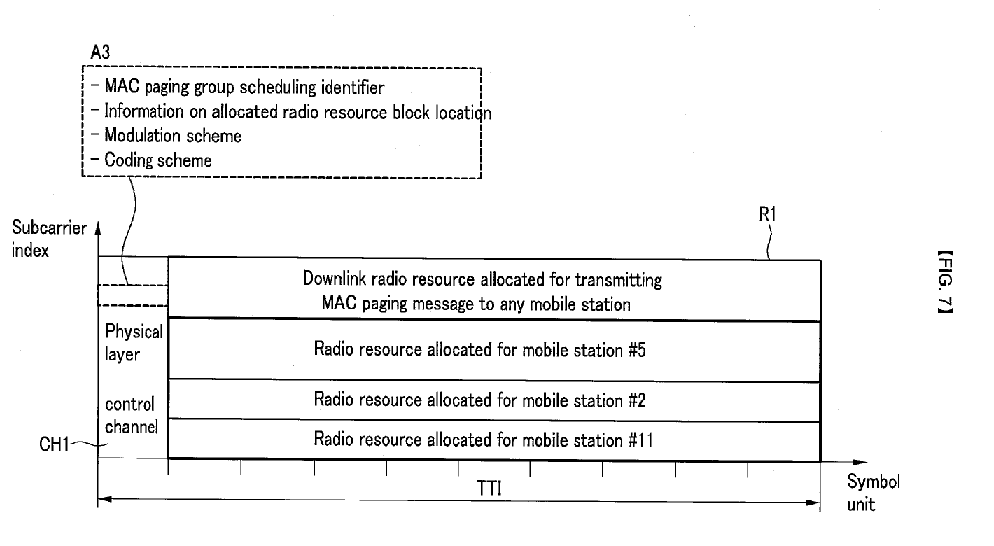

FIG. 7 is a second illustrative view of the radio resource for transmitting the paging message in the method of transmitting the paging information according to the second exemplary embodiment of the invention.

The base station 100 may be employed by previously reserving and allocating a part of the identifiers for performing the scheduling of the mobile station as a group identifier for transmitting the MAC paging message. Here, the group identifier may be designated as a MAC paging group scheduling identifier.

By using the MAC paging group scheduling identifier described above, the MAC paging message can be transmitted to a plurality of mobile stations through the same downlink radio resource. In this case, the base station 100 is composed of radio resource allocation information A3 to be transmitted to a physical layer control channel CH1, and the radio resource allocation information A3 includes the MAC paging group scheduling identifier and the information on radio resource block location for transmitting the MAC paging message. Furthermore, the base station 100 generates the MAC paging messages including the scheduling identifiers of each mobile station included in the MAC paging group through the allocated downlink radio resource, the information on preamble pattern used when performing the procedure of the random access for acquiring the uplink synchronization, and the information including the paging reason. Moreover, the base station 100 transmits the generated MAC paging messages to the mobile stations through the same downlink radio resource.

In this case, the mobile stations acquire the radio resource allocation information A3 including the MAC paging group scheduling identifier through the physical layer control channel. For this reason, the mobile stations perform the procedure for acquiring the uplink synchronization described above by receiving the MAC paging message transmitted through the radio resource.

According to the second exemplary embodiment of the invention, it is possible to efficiently transmit the paging information to the mobile stations that do not maintain the uplink synchronization in the RRC-Connected state. Moreover, in a case of transmitting the paging information, it is possible to efficiently utilize the limited radio resource by occupation of the radio resource.

Furthermore, according to the exemplary embodiments of the invention described above, since the mobile station performs the random access procedure by generating the preamble based on the preamble pattern included in the MAC paging message, the random access procedure may be performed without contention. Accordingly, it is possible to prevent the conflict of the preambles transmitted from the different mobile stations and the procedure processing delay due to the conflict of the preambles. However, the invention is not limited thereto, but may generate the preamble by randomly selecting the preamble pattern among a plurality of preamble patterns provided to the mobile station through the system information. Naturally, in this case, the base station subjects the preamble pattern information so as to not be included in the MAC paging message during the transmission of the MAC paging message.

The exemplary embodiment of the invention can be not necessarily realized by only the above-described apparatus and/or method, but can be realized by, for example, a program that achieves the function corresponding to the configuration of the exemplary embodiment of the invention and a recording medium in which the program is recorded. This will be easily realized from the above-described exemplary embodiment by those skilled in the related art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of transmitting paging information indicating the start of downlink information transmission to a mobile station performing a low-power-consumption operation at an active state in a mobile communication system, the method comprising:
confirming whether the mobile station maintains uplink physical layer synchronization when the downlink information transmission to the mobile station is started;
transmitting a paging message to the mobile station when the mobile station does not maintain uplink physical layer synchronization; and
allocating an uplink radio resource to the mobile station by request of uplink synchronization acquisition from the mobile station that receives the paging message.

2. The method of claim 1, wherein the transmitting of the paging message includes transmitting radio resource allocation information corresponding to the paging message to the mobile station through only a physical layer control channel, the information including information indicating a mobile station identifier and paging reason.

3. The method of claim 1, wherein the transmitting of the paging message comprises:
allocating a downlink radio resource for transmitting the paging message to the mobile station;
transmitting radio resource allocation information through a physical layer control channel, the radio resource allocation information including the mobile station identifier and information on the allocated downlink radio resource; and
transmitting the paging message through the allocated downlink radio resource, the message including information that indicates a paging reason.

4. The method of claim 3, wherein the mobile station identifier is a paging group scheduling identifier that is reserved and allocated as a group identifier for transmitting the paging message among scheduling identifiers.

5. The method of claim 1, wherein the paging message includes preamble pattern information for generating signals for the uplink synchronization acquisition.

6. The method of claim 1, wherein the paging message is a MAC (medium access control) paging message.

7. A method of performing paging by a mobile station that performs a low-power-consumption operation at an active state in a mobile communication system, the method comprising:
receiving a MAC (medium access control) paging message from a base station as the mobile station starts to transmit downlink information;
requesting uplink synchronization acquisition to the base station based on the paging message; and
receiving allocation of an uplink radio resource from the base station according to the uplink synchronization acquisition.

8. The method of claim 7, wherein the receiving of the paging message includes receiving radio resource allocation information corresponding to the paging message through a physical layer control channel, the information including information indicating a mobile station identifier and paging reason.

9. The method of claim 7, wherein the receiving of the paging message comprises:
receiving radio resource allocation information through a physical layer control channel, the radio resource allocation information including a mobile station identifier and information on a radio resource allocated for transmitting the paging message; and
receiving the paging message to be transmitted from a downlink radio resource based on the information on the allocated radio resource, the message including information that indicates a paging reason.

10. The method of claim 7, wherein
the paging message includes preamble pattern information for generating signals for the uplink synchronization acquisition, and
the requesting of the uplink synchronization acquisition includes:
generating a preamble signal based on the preamble pattern information; and
requesting uplink synchronization acquisition while transmitting the preamble signal to the base station.
